(19) United States
(12) Patent Application Publication
(10) Pub. No.: US 2013/0125148 A1
(43) Pub. Date: May 16, 2013

(54) OPTICAL DISC DRIVE

(71) Applicants: Sz-Shian He, Hsinchu City (TW); Yung-Han Wu, Hsinchu City (TW); Wei-Chieh Hu, Hsinchu City (TW); Shih-Ming Hsu, Hsinchu City (TW); Sheng-Fa Hou, Hsinchu City (TW); Ho-Ting Hsieh, Hsinchu City (TW); In-Shuen Lee, Hsinchu City (TW)

(72) Inventors: Sz-Shian He, Hsinchu City (TW); Yung-Han Wu, Hsinchu City (TW); Wei-Chieh Hu, Hsinchu City (TW); Shih-Ming Hsu, Hsinchu City (TW); Sheng-Fa Hou, Hsinchu City (TW); Ho-Ting Hsieh, Hsinchu City (TW); In-Shuen Lee, Hsinchu City (TW)

(73) Assignee: PHILIPS & LITE-ON DIGITAL SOLUTIONS CORPORATION, TAIPEI CITY (TW)

(21) Appl. No.: 13/339,351

(22) Filed: Dec. 28, 2011

(30) Foreign Application Priority Data
Nov. 15, 2011 (CN) 201110361276.9

(51) Int. Cl. G11B 17/03

(52) U.S. Cl. 720/601; G9B/17.009

(57) ABSTRACT

An optical disc drive including a case, a tray, a traverse, a plurality of washers, a plurality of fastening elements and a plurality of adjustment elements is provided. The tray is suitable for carrying an optical disc and includes a plurality of hollow alignment pillars. The traverse is disposed on the tray and includes a plurality of alignment holes for containing the corresponding hollow alignment pillars. Each washer is disposed in each of the alignment holes and leans between each of the alignment holes and each of the hollow alignment pillars. The fastening elements lock the traverse onto the tray. Each adjustment element leans between each of the washers and the tray, and bears an engagement pressure.

### CROSS-REFERENCE TO RELATED APPLICATION

This application claims the priority benefit of China application serial no. 201110361276.9, filed on Nov. 15, 2011. The entirety of the above-mentioned patent application is hereby incorporated by reference herein and made a part of this specification.

### BACKGROUND OF THE INVENTION

1. Field of the Invention

The present invention relates to an optical disc drive, and more particularly to an optical disc drive capable of adjusting a deflection state of a traverse thereof

2. Description of Related Art

With respect to the precision of the hardware of an optical disc drive, apart from the precision of individual components during manufacturing, the precision of assembling an optical disc drive components is also a key factor that decides whether an optical disc can be read correctly or not. As volumes of optical disc drives available on the market are becoming smaller and smaller, internal spaces thereof are greatly limited. Therefore, if the disposition between the traverse of the optical disc drive and other peripheral assemblies thereof fails to meet the precision requirement, for example, when the position of the traverse of the optical disc drive deflects, with a high spinning speed, the optical disc disposed on a spindle motor is likely to rub a shell of the optical disc drive or other structures therein, thereby generating noise and causing damages to the optical disc and the optical disc drive.

Furthermore, with respect to the production process of the optical disc drive, when assembly of the optical disc drive is finished and product testing is performed, if it is detected that the traverse of the optical disc drive is in a deflection state, in the conventional optical disc drive, the traverse of the optical disc drive must be dismounted and reassembled to adjust the position of the traverse of the optical disc drive. The process of dismounting, adjusting and reassembling takes a great portion of the testing time, and meanwhile is production cost consuming.

### SUMMARY OF THE INVENTION

The present invention is directed to an optical disc drive such that the deflection state of the traverse thereof can be adjusted.

The present invention provides an optical disc drive including a case, a tray, a traverse, a plurality of washers, a plurality of fastening elements and a plurality of adjustment elements. The tray is suitable for carrying an optical disc and includes a plurality of hollow alignment pillars. The traverse is disposed on the tray and includes a plurality of alignment holes for containing the corresponding hollow alignment pillars. Each washer is disposed in each of the alignment holes and leans between each of the alignment holes and each of the hollow alignment pillars. The fastening elements lock the traverse onto the tray. Each adjustment element leans between each of the washers and the tray, and is bearing an engagement pressure.

Based on the above, the present invention utilizes an elastic adjustment element disposed between the washer and the tray, so that after being fastened at a fastening position, the fastening element can continue to move along a fastening direction by utilizing an elastic strain provided by the adjustment element. In this manner, when the traverse is deflected due to a manufacturing tolerance or other reasons, fine tuning along the fastening direction may be directly performed on the fastening element that needs to be adjusted, so that the reassembly can be avoid. Therefore, the present invention not only facilitates the assembly of the optical disc drive, but also saves assembly time.

In order to make the aforementioned features and advantages of the present invention comprehensible, embodiments are described in detail below with reference to the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional schematic view of an optical disc drive according to an embodiment of the present invention.

FIG. 2 is an exploded schematic view of members of an optical disc drive in FIG. 1.

FIG. 3 is a cross-sectional schematic view of FIG. 1 along an I-I line.

FIG. 4A and FIG. 4B are schematic views of an adjustment element according to two different embodiments of the present invention.

FIG. 5 is a schematic view of fastening between a conventional traverse without an adjustment element and a tray.

FIG. 6 to FIG. 8 are schematic views of a fastening process of a traverse with an adjustment element and a tray according to an embodiment of the present invention.

FIG. 9 is a cross-sectional schematic view of local members according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

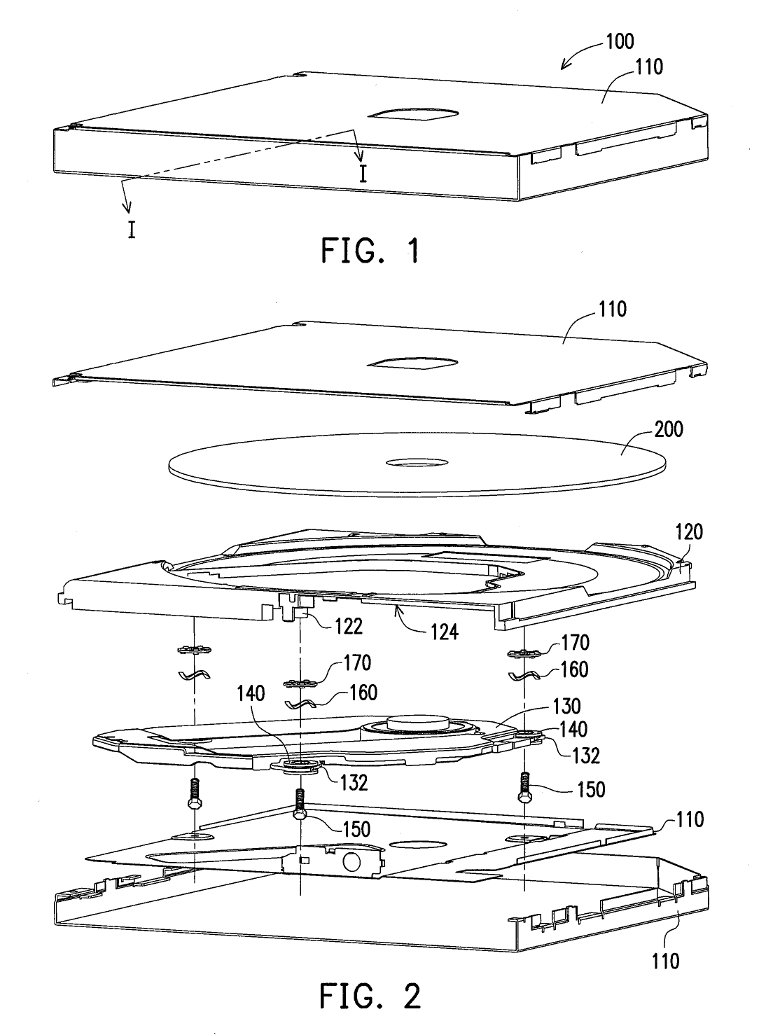

FIG. 1 is a three-dimensional schematic view of an optical disc drive according to an embodiment of the present invention. FIG. 2 is an exploded schematic view of members of an optical disc drive in FIG. 1. Referring to FIG. 1 and FIG. 2, an embodiment of the present invention provides an optical disc drive 100, which includes a case 110, a tray 120, a traverse 130, a plurality of washers 140, a plurality of fastening elements 150 and a plurality of adjustment elements 160. The tray 120 is suitable for carrying an optical disc 200, and a lower surface 124 of the tray 120 includes a plurality of hollow alignment pillars 122, and the hollow alignment pillars 122 protrude from the lower surface 124. The traverse 130 is disposed on the lower surface 124 of the tray 120 and includes a plurality of alignment holes 132 for containing the corresponding hollow alignment pillars 122. Each washer 140 is disposed in each of the alignment holes 132 and leans between each of the alignment holes 132 and each of the hollow alignment pillars 122. The fastening element 150 is locked with the hollow alignment pillar 122, to lock the traverse 130 onto the lower surface 124 of the tray 120, and in the present embodiment, the fastening element 150 is a screw. Each adjustment element 160 leans between each of the washers 140 and the tray 120, and is bearing an engagement pressure PF.

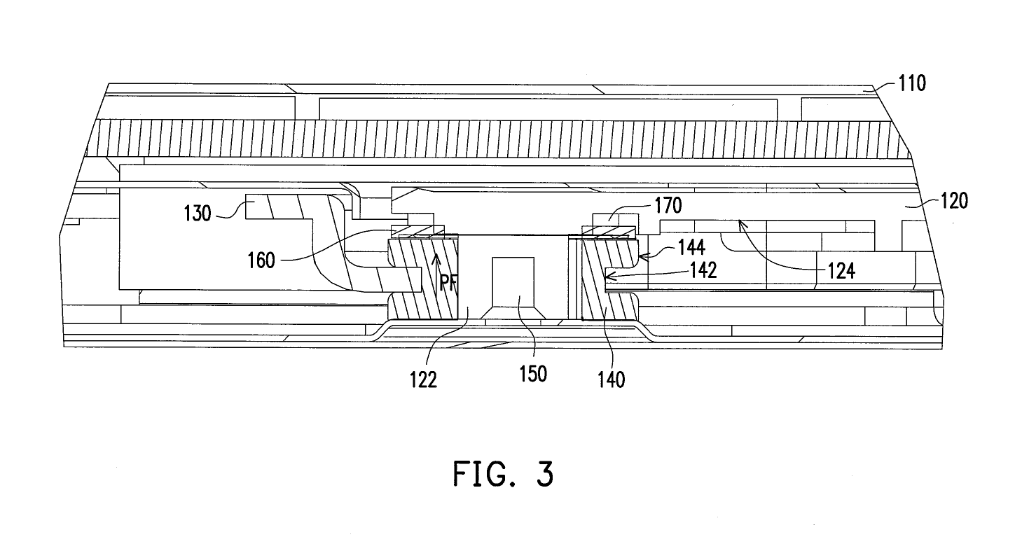

FIG. 3 is a cross-sectional schematic view of FIG. 1 along an I-I line. As shown in FIG. 3, each washer 140 includes a groove 142 surrounding an outer surface 144 thereof, to be engaged with an inner edge of the corresponding alignment hole 132, so that the washer 140 firmly leans between the alignment hole 132 and the hollow alignment pillar 122. The adjustment element 160 leans between the washer 140 and the tray 120, bears the engagement pressure PF when the tray 120 and the traverse 130 are in a fastened state, and generates a corresponding elastic strain.

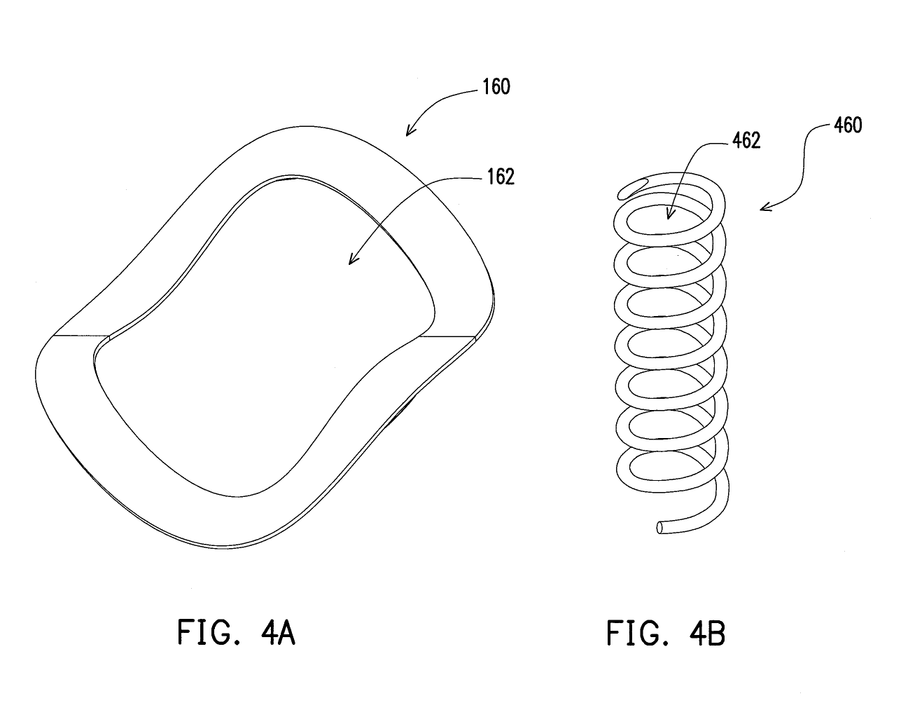

FIG. 4A and FIG. 4B are schematic views of an adjustment element according to two different embodiments of the present invention. Referring to FIG. 4A, in this embodiment, the adjustment element 160 is a wave spring, and includes a through hole 162 in the center, to contain the hollow alignment pillar 122 and lean between the washer 140 and the tray 120. In another embodiment of the present invention, the adjustment element may also be a spiral spring 460, contains the hollow alignment pillar 122 with a through hole 462 in the center, and leans between the washer 140 and the tray 120. The present invention does not limit the figure of the adjustment element 160, as long as the adjustment element 160 leans between the washer 140 and the tray 120, can bear the engagement pressure PF and generate the corresponding elastic strain, persons skilled in the art may make variations to the figure of the adjustment element 160. In addition, as shown in FIG. 2, the optical disc drive 100 may further include a plurality of pads 170 leaning between the adjustment elements 160 and the lower surface 124 of the tray 120, to buffer the pressure.

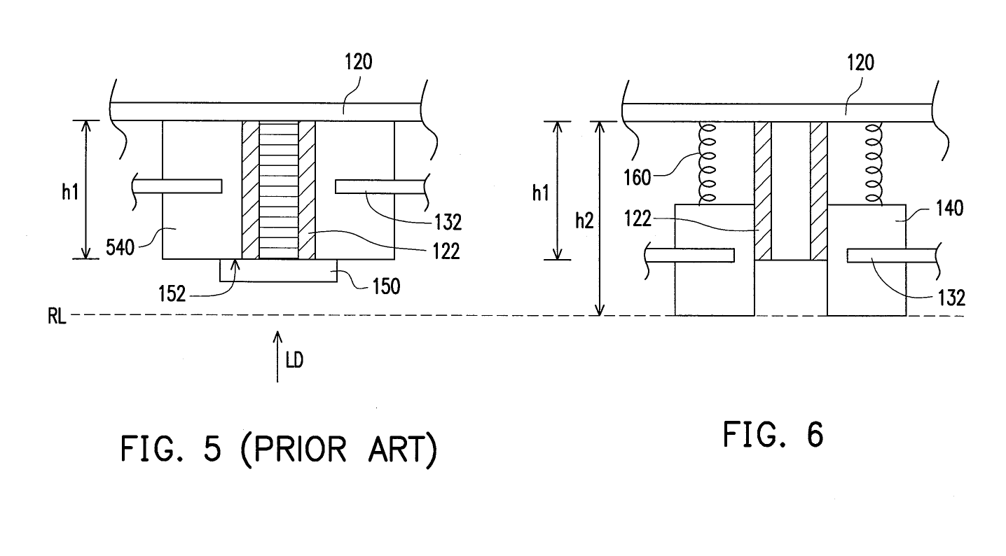

FIG. 5 is a schematic view of fastening between a conventional traverse without an adjustment element and a tray. Referring to FIG. 5, in the conventional optical disc drive without an adjustment element, a length of a washer 540 thereof is equal to a length h1 of the hollow alignment pillar 122, and the fastening element 150 is locked to a deepest position along a locking direction LD, so that a leaning surface 152 leans against the hollow alignment pillar 122. At this time, the fastening element 150 is incapable of further moving along the locking direction LD, and therefore, when the traverse 130 is deflected due to the manufacturing tolerance or other factors, the fastening element 150 cannot further adjust the position thereof.

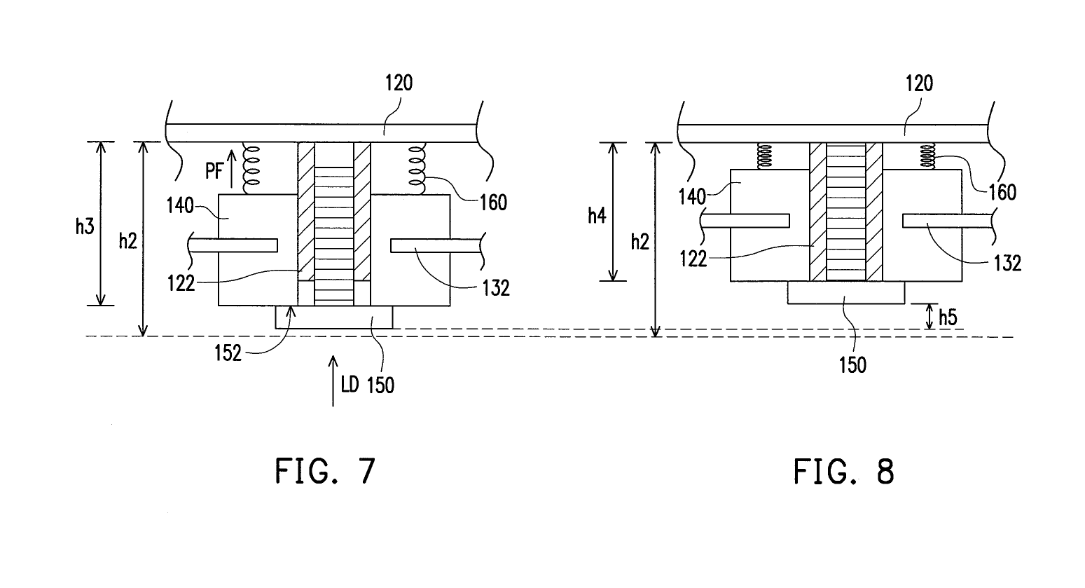

FIG. 6 to FIG. 8 are schematic views of a fastening process of a traverse with an adjustment element and a tray according to an embodiment of the present invention. Referring to FIG. 6, in this embodiment, the adjustment element 160 is disposed between the washer 140 and the tray 120, so that without pressure, a length of the adjustment element 160 plus a length of the washer 140 are a free length h2, and the free length h2 is greater than the length h1 of the hollow alignment pillar 122. For the convenience of comparison and illustration, in FIG. 5 to FIG. 8, a reference line RL is drawn at a position of the free length h2, to facilitate comparison of the positions in different locking situations. Further referring to FIG. 7, the free length h2 is greater than the length h1 of the hollow alignment pillar 122, and when the fastening element 150 is locked in to the hollow alignment pillar 122 along the locking direction LD, the fastening element 150 pushes the washer 140 to move along the locking direction LD and makes the adjustment element 160 bear an engagement pressure PF to further generate a corresponding elastic deformation. When the fastening element 150 is locked into the hollow alignment pillar 122 and reaches an initial position shown in FIG. 7, an effective locking relation can be achieved between the fastening element 150 and the hollow alignment pillar 122 through a reacting force generated by the adjustment element 160 bearing the engagement pressure PF. The original free length h2 is compressed to a first compression length h3, and at this time, the traverse 130 may be firmly locked on the tray 120 and a distance is maintained between the leaning surface 152 of the fastening element 150 and a top end of the hollow alignment pillar 122, that is, the first compression length h3 is greater than the length h1 of the hollow alignment pillar 122, so as to provide a space for subsequent adjustment of a locking depth of the fastening element 150.

In view of the above, when the traverse 130 is deflected due to the manufacturing tolerance or other factors, as the leaning surface 152 of the fastening element 150 does not lean against the hollow alignment pillar 122, the locking depth of the fastening element 150 may be adjusted according to the deflection of the traverse 130. As shown in FIG. 8, the fastening element 150 may continue to push the adjustment element 160 along the locking direction LD to produce the elastic deformation, so that the fastening element 150 continues to move along the locking direction LD until the leaning surface 152 thereof leans against the hollow alignment pillar 122. The first compression length h3 may be compressed, by a maximum degree, to a second compression length h4 as shown in FIG. 8. In other words, a length for which the fastening element 150 can continue to move after the initial position is an adjustable length h5 provided by the adjustment element 160, where the adjustable length h5 is substantially a difference value between the first compression length h3 and the second compression length h4.

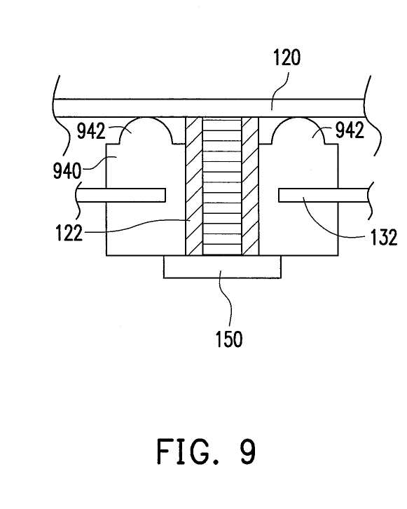

FIG. 9 is a cross-sectional schematic view of local members according to another embodiment of the present invention. In another embodiment of the present invention, the adjustment element may be integrally formed with the washer, to form a washer 940 as shown in FIG. 9, namely, the adjustment element becomes a part of the washer 940. In this embodiment, a top surface of the washer 940 includes a bump 942, and a function of the bump 942 is the same as that of the above adjustment element 160. The bump 942 leans against the tray 120, to provide an appropriate elastic allowance after an effective locking relation is formed between the fastening element 150 and the hollow alignment pillar 122 for further adjustment of the locking depth of the fastening element 150.

Based on the above, the present invention utilizes an adjustment element capable of generating an elastic strain and disposed between the washer and the tray, so that after being fastened at a fastening position, the fastening element can continue to move along a fastening direction by utilizing the elastic strain provided by the adjustment element. In this manner, when the traverse is deflected, fine tuning along the fastening direction can be directly performed on the fastening element that needs to be adjusted without dismounting and reassembling the traverse. In addition, the adjustment element may also be integrally formed with the washer, to simplify complexity of assembly. Therefore, the present invention not only facilitates the assembly of the optical disc drive, but also saves assembly time of the optical disc drive.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive, comprising:
a case;
a tray, suitable for carrying an optical disc and comprising a plurality of hollow alignment pillars;
a traverse, disposed on the tray and comprising a plurality of alignment holes for containing the corresponding hollow alignment pillars;
a plurality of washers, respectively disposed in each of the alignment holes and leaning between each of the alignment holes and each of the hollow alignment pillars;
a plurality of fastening elements, locking the traverse onto the tray; and
a plurality of adjustment elements, respectively leaning between each of the washers and the tray and bearing an engagement pressure.

2. The optical disc drive according to claim 1, wherein the hollow alignment pillars protrude from a lower surface of the tray, and the traverse is locked onto the lower surface of the tray.

3. The optical disc drive according to claim 1, wherein the fastening element comprises a screw.

4. The optical disc drive according to claim 1, wherein the adjustment element comprises a wave spring.

5. The optical disc drive according to claim 1, wherein the adjustment element comprises a spiral spring.

6. The optical disc drive according to claim 1, wherein the adjustment element is integrally formed with the washer.

7. The optical disc drive according to claim 1, wherein each of the washers further comprises a groove, located on an outer surface of the washer, to be engaged with the alignment hole.

8. The optical disc drive according to claim 1, wherein the optical disc drive further comprises a plurality of pads, respectively leaning between each of the adjustment elements and the lower surface.
